(19) United States
(12) Patent Application Publication
(10) Pub. No.: US 2022/0338678 A1
(43) Pub. Date: Oct. 27, 2022

(54) MULTI-PURPOSE FOOD PREPARATION MACHINE WITH REPLACEABLE PROCESSOR

(71) Applicants: KUO-I LIN, New Taipei City (TW); FU-CHEN LIN, New Taipei City (TW)

(72) Inventors: KUO-I LIN, New Taipei City (TW); FU-CHEN LIN, New Taipei City (TW)

(21) Appl. No.: 17/314,011

(22) Filed: May 6, 2021

(30) Foreign Application Priority Data
Apr. 23, 2021 (TW) 110204655

(51) Int. Cl. A47J 44/00; A47J 19/02; A47J 19/06; A47J 43/06; A21C 11/16; B02C 18/14

(52) U.S. Cl. CPC A47J 44/00; A47J 19/02; A47J 19/06; A47J 43/06; A21C 11/16; B02C 18/144

(57) ABSTRACT

A processor-changeable multipurpose food preparation machine, comprises a actuator and a processor, a fixing base is arranged outside the insertion hole of the actuator, the outer end has a coupling mouth, the upper end has a first feed inlet, the two side ends have a first fixing part; the tail end of the processor includes a feeding base, the upper end has a second feed inlet, the two side ends have a second fixing part; the feeding base is inserted in the coupling mouth of fixing base and fixed into the fixing base, the second feed inlet corresponds to the lower part of the first feed inlet, when the second fixing part is coordinated with the first fixing part, the feeding base and fixing base are combined by a fastener, the processor can be assembled or changed easily and quickly, the operation is convenient and easily learned.

### BACKGROUND OF INVENTION

### 1. Field of the Invention

The present invention relates generally to a domain of food processors, and more particularly to a processor-changeable multipurpose food preparation machine, the processor refers to oil manufacture processor, grinding processor, juicing processor and noodle squeezing processor.

### 2. Description of Related Art

The food preparation machines are small household appliances used constantly at home, such as juicers, grinders, oil presses and noodle squeezers, the users can prepare food by themselves at home, the preparation is interesting, convenient, economic and time saving. However, these food preparation machines are mostly used as a single unit, buying all of them will cost a lot and occupy space. Therefore, some supplier thought out a design which combined the actuator with processors for different purposes, but it was difficult to assemble or change the processor, difficult to operate and learn, and the structure was complex, the manufacturing cost was high, unfavorable for the supplier to popularize, or for the consumers to use. Therefore, it is necessary to further improve the multipurpose food preparation machine.

Among the food preparation machines, the juicer squeezes juice and residue out of vegetable and fruit, The noodle squeezer extrudes noodles from the dough. However, the oil press and grinder do not process vegetable and fruit and dough, but squeeze oil or grind paste out of nuts and seeds. The latter two processors process nuts and seeds, their combination with the actuator is very adaptive, favorable for the consumers to use, and favorable for the suppliers to market.

In view of this, how to solve the above problems is the topic to be broken through by the present invention.

### SUMMARY OF THE INVENTION

In order to solve the above technical problems and achieve the purpose of the present invention, the present invention adopts the following technical solutions, which is a multi-purpose food preparation machine with a replaceable processor, comprising an actuator and a processor, wherein the actuator includes a motor as a power output, an insertion hole disposed at an output of the actuator; the processor is a hollow tubular body, one end of which is fixed to the motor of the actuator, the processor includes a screw rod provided in the hollow tubular body of the processor, one end of the screw rod has an insertion rod, which can be sleeved with a motor shaft disposed in the actuator; the actuator includes a fixing base, which is a hollow and has an inner end connected with the insertion hole, a coupling mouth disposed at an outer end of the fixing base, a first feeding inlet disposed at an upper end of the fixing base, and first fixing part disposed on both sides of the fixing base, the processor includes a feeding base disposed at one end thereof, the feeding base is a hollow and includes an axial hole disposed at outer end of the feeding base, a second feeding inlet disposed at an upper end of the feeding base, and second fixing part disposed on both sides of the feeding, base; the feeding base is inserted and installed in the fixing base by the coupling mouth of the fixing base; the second feed inlet is directly below and corresponds to the first feed inlet; the second fixing part and the first fixing part are inserted through a fastener to connect and fix the feeding base and the fixing base; an inner wall of the coupling mouth of the fixing base has at least one plane, an outer wall of the feeding base has at least one plane that matches the plane of the inner wall of the coupling mouth.

More particularly, wherein the first fixing part of the fixing base is left and right plug holes for the fastener inserted therethrough, the second fixing part of the feeding base is perforations for the fastener inserted therethrough, when the perforations are aligned with the left and right plug holes, the pin can be inserted directly.

More particularly, wherein the first fixing part of the fixing base includes the left and right plug holes for inserting the fastener and a first slot between two plug holes, the second fixing part of the feeding base is a second slot for inserting the fastener, the fastener is a pin, when the second slot and the first slot are vertically opposite to each other and coordinated with the left and right plug holes, the pin can be inserted directly.

More particularly, the discharge part under the funnel can be inserted in the first feed inlet of the fixing base, the inner wall of the first feed inlet is provided with a flange for stopping the discharge part.

More particularly, the upper edge of the power outlet of the actuator is provided with a lift type cover plate, the cover plate is provided with a feed inlet vertically corresponding to the first feed inlet of the fixing base.

More particularly, wherein the bottom surface of the cover plate is provided with a heater far from the first feed inlet for contacting the processor and heating the processor.

More particularly, wherein the processor is an oil manufacture processor for squeezing vegetable oil, the outer wall of the oil manufacture processor is provided with a heat conducting outer tube contacting the heater.

More particularly, wherein the processor is a grinding processor for grinding out paste food.

More particularly, wherein the processor is a juicing processor for squeezing vegetable and fruit juice.

More particularly, wherein the processor is a noodle squeezing processor for extruding noodles.

Upon the adoption of the technical proposal, the present invention has the following beneficial effects compared with the existing technology:

The present invention arranges a fixing base outside the actuator, a feeding base is arranged at the tail end of processor, when the feeding base is inserted in the fixing base, they are combined, at this point, the first fixing part of fixing base is coordinated with the second fixing part of feeding base, and fixed by a fastener, so that the fixing base will not be disengaged from the feeding base, the simple operation, easy assembly or disassembly, the processor can be changed quickly and conveniently.

To endue the food preparation machine with oil squeezing or grinding function, the oil manufacture processor and grinding processor are combined with the actuator, so as to make two different food products out of nuts and seeds simultaneously.

When the first fixing part is a plug hole, the second fixing part is a perforation, and the fastener is a pin, the plug hole is aligned with the perforation for inserting the pin, and then the fixing base can be fixed to the feeding base, the structure is simple, the manufacture is easy, the cost is low, and it is easy for users to learn and operate.

The inner wall of the coupling mouth of the fixing base has at least one plane, and the outer wall of the feeding base has at least one plane, when the feeding base is inserted in the fixing base, their planes match each other, preventing the feeding base from getting loose.

### BRIEF DESCRIPTION OF THE DRAWINGS

FIG. l is an exploded diagram of the first embodiment of the multipurpose food preparation machine of the present invention.

FIG. 2 is. a section view of the combination of the fixing base and feeding base in FIG, 1;

FIG. 3 is an exploded diagram of another combination of the actuator and oil manufacture processor of the present invention;

FIG. 4 is a section view of the combination of the fixing base and feeding base in FIG. 3;

FIG. 5 is a schematic diagram of combination of the actuator and oil manufacture processor of the present invention;

FIG. 6 is a schematic diagram of combination of the actuator and grinding processor of the present invention;

FIG. 7 is an exploded diagram of the second embodiment of the multipurpose food preparation machine of the present invention.

### DETAILED DESCRIPTION OF THE INVENTION

The detailed description is given below according to the embodiments and figures.

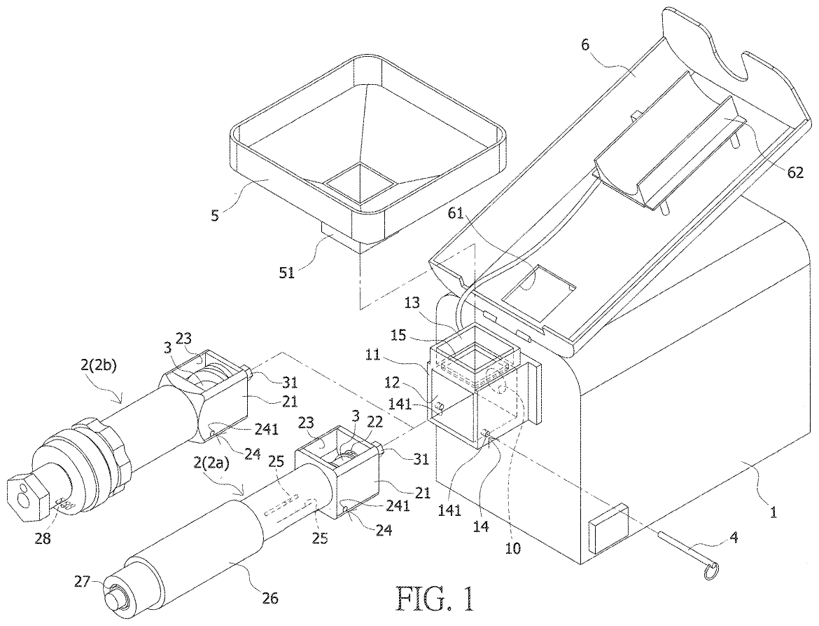

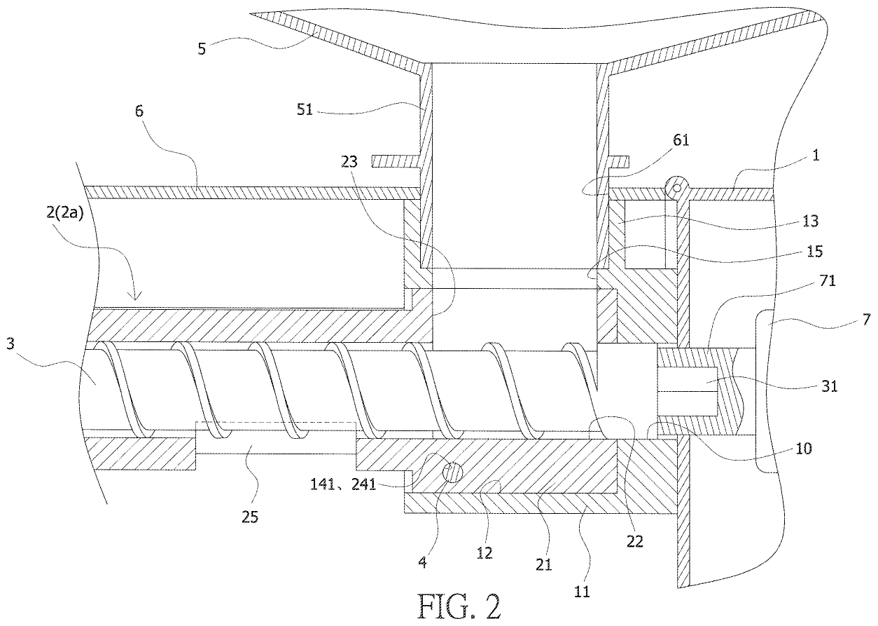

As shown in FIG. 1 and FIG. 2, a processor-changeable multipurpose food preparation machine is disclosed, which comprises a actuator 1. and a processor 2. There are different types of the processor 2 with different functions, in the following description, the processors 2 for different purposes introduced individually are represented by other symbols, the other processors are represented by symbol 2. A motor 7 as power output source is arranged in the actuator 1, an insertion hole 10 is arranged in the power outlet. The processor 2 is a hollow tube-like body, the tail end is fixed to the power outlet of actuator 1, the hollow processing chamber in the tube has a. screw rod 3 for extrusion, the insertion rod 31 at the tail end of the screw rod 3 can be combined with the motor shaft 71 in the actuator 1. The structure of the actuator 1 approximates to the structure of traditional juicer, which is a known structure; and the combination of the insertion rod 31 at the tail end of screw rod 3 and the motor shaft 71 is a widely-known technology, not to he detailed.

Features of this case: a fixing base 11 is arranged outside the insertion hole 10 of the actuator 1, the fixing base 11 is hollow, and the inner end communicates with the insertion hole 10, the outer end has a coupling mouth 12 for inserting the processor 2, the upper end has a naked first feed inlet 13, the two side ends are provided with a first fixing part 14 for fixing. A feeding base 21 is arranged at the tail end of the processor 2, the feeding base 21 is hollow, and the inner end communicates with the processing chamber, the outer end has an axial hole 22 for the insertion rod 31 of screw rod 3 to extend out, the upper end has a naked second feed inlet 23, the two side ends are provided with a second fixing part 24 for fixing. The feeding base 21 at the tail end of the processor 2 is inserted in the coupling mouth 12 of the fixing base 11 and fixed into the hollow fixing base 11. The second feed inlet 23 can be arranged below the first feed inlet 13, after the second fixing part 24 is coordinated with the first fixing part 14, the fastener 4 is applied to fix the feeding base 21 to the fixing base 11.

The inner wall of the coupling mouth 12 of the hollow fixing base 11 has at least one plane, the outer wall of the feeding base 21 has at least one plane matching, the plane on the inner wail of the coupling mouth 12, when the two planes coordinate with each other, there will not be gyration, and the more planes there are, the better is the effect. As shown in the figure, the fixing base 11 is square, the inner wall of coupling mouth 12 has four planes, and the feeding base 21 is square, the outer wall has four planes, so the feeding base 21 is inserted in the fixing base 11, after the two planes match each other, the firmness is enhanced greatly.

The combination of the first fixing part 14 and the second fixing part 24 can be fixed by the fastener 4 by multiple means, but in order to let the user learn and operate easily, and for rapid fixing, firm combination, easy disassembly, simple structure, easy manufacture and low processing cost, this case uses the following means, the first fixing part 14 of the fixing base 11 is the left and right plug holes 141, the second fixing part 24 of the feeding base 21 is a perforation 241, the fastener 4 is a pin, when the perforation 241 coordinates with the left and right plug holes 141, the pin can be inserted directly to implement rapid fixing. This means to rapidly fix the feeding base 21 and fixing base 11 enables the user to learn quickly and operate easily. On the contrary, to remove the feeding base 21, as long as the pin is pulled out, the feeding base 21 can be disconnected from the fixing base 11 quickly.

Secondly, the first fixing part 14 and the second fixing part 24 must he lower than the screw rod 3, so that the fastener 4 will not contact the screw rod 3 after it is inserted. Therefore, the fastener 4 is located below the screw rod 3, this is the best location.

The discharge part 51 under the funnel 5 can be inserted in the first feed inlet 13 of the fixing base 11, so that the funnel 5 is connected to the upper part of the first feed inlet 13. The inner wall of the first feed inlet 13 of the fixing base 11 is provided with an annular flange 15 to prevent the discharge part 51 from being excessively inserted in the fixing base 11.

The upper edge of the power outlet of the actuator 1 is provided with a lift type cover plate 6, they are combined by a hinge or a plug, thus, the cover plate 6 can be turned. The cover plate 6 is provided with a feed inlet 61 vertically corresponding to the first feed inlet 13 of the fixing base 11, so the funnel 5 can be inserted in the first feed inlet 13 of fixing base 11 through the feed inlet 61 by means of the discharge part 51.

The bottom surface of the cover plate 6 is provided with a heater 62 far from the first feed inlet 13 for contacting the processor 2 and heating the processor 2. When the nuts and seeds are heated in the tube of processor 2, they are softened to discharge oil. As the cover plate 6 covers the processor 2, it prevents the user from being scalded by the high temperature processor 2 by accident, the cover plate 6 is a protector.

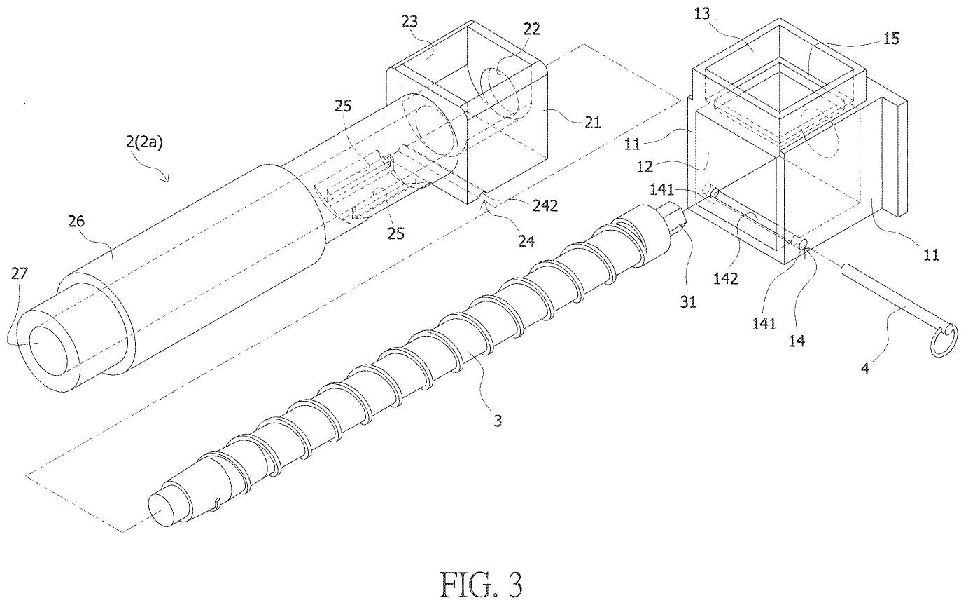

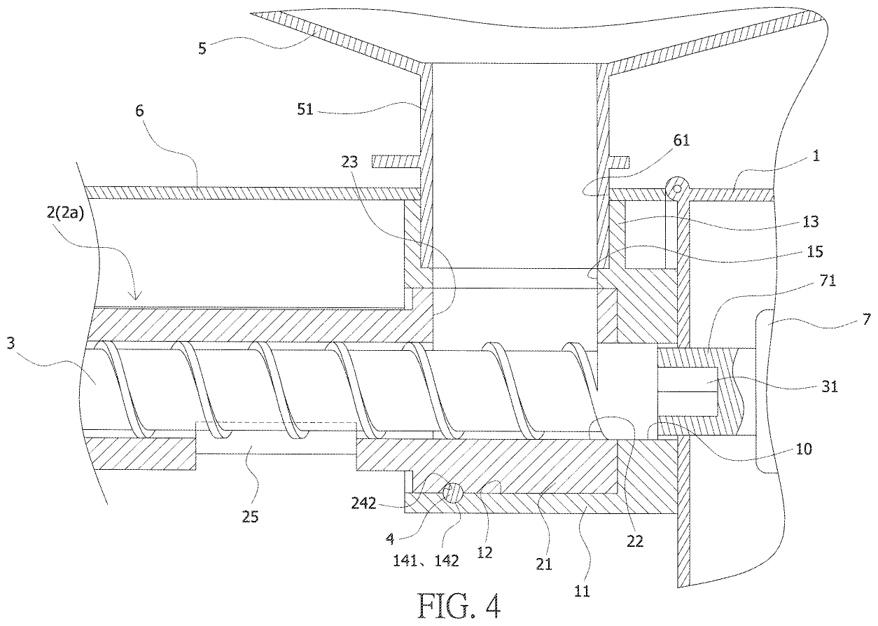

FIG. 3 and FIG. 4 show a fixing method different from the first fixing part 14 and the second fixing part 24, the first fixing part 14 comprises the left and right plug holes 141 for inserting the fastener 4 and a first slot 142 between two plug holes 141, the second fixing part 24 is a second slot 242 for inserting the fastener 4, the fastener 4 is still a pin. When the feeding base 21 is inserted in the fixing base 11, the second slot 242 and the first slot 142 are vertically opposite to each other and coordinated with the left and right plug holes 141, so that the pin can be inserted directly to combine the feeding base 21 with the fixing base 11. The sectional form of the first slot 142 and the second slot 242 is semicircular, when they are vertically opposite: to each other, a circle is formed for inserting the pin.

FIG. 1 has described multiple types of processor 2, two kinds of processor 2 are listed in the embodiment in FIG. 1, including an oil manufacture processor 2a for squeezing vegetable oil out of nuts and seeds and a grinding processor 2b for grinding paste out of nuts and seeds. The vegetable oil includes peanut oil, sesame oil, sunflower seed oil and so on. The paste includes peanut butter, sesame paste, pumpkin seed paste and so on. This case lays special emphasis on combining the oil manufacture processor 2a and grinding processor 2h with the actuator 1. There is not yet a combination of the processors 2a and 2b and the actuator 1 on the market.

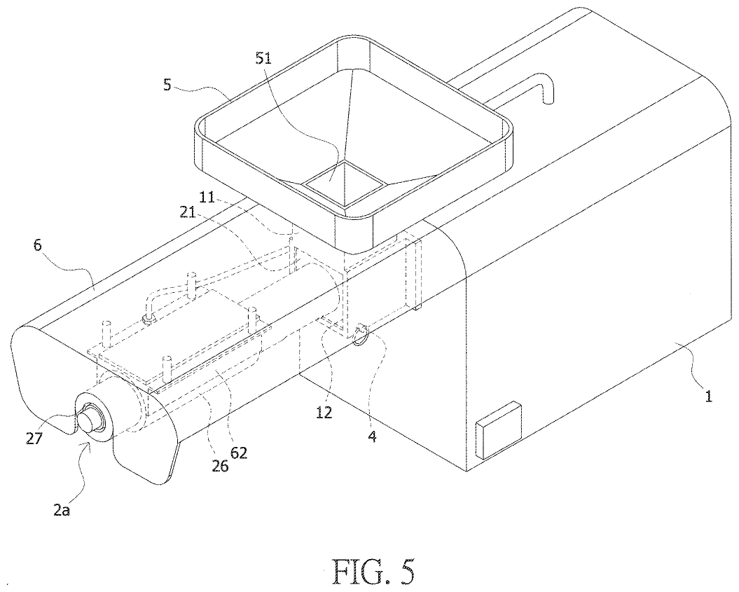

FIG. 1 and FIG. 5 show the combination of the oil manufacture processor 2a and actuator 1, the feeding base 21 at the tail end of the oil press 2a and the fixing base 11 of actuator 1 must he combined and fixed by inserting the pin 4, and then the cover plate 6 covers the oil press 2a, the funnel 5 is inserted in the fixing base 11, the nuts and seeds are poured into the funnel 5, passing through the fixing base 11 and the feeding base 21, they are extruded by the screw rod 3 into the tube of the oil manufacture processor 21. As the nuts and seeds must be heated and softened before the oil is extracted, the oil manufacture processor 2a must abut on the heater 62 of the cover plate 6. As the caliber of oil manufacture processor 2a is small, in order to closely match the heater 62, the outer wall is provided with a heat conducting outer tube 26 superficially contacting the heater 62, the oil manufacture processor 2a is heated rapidly as the heat conducting outer tube 26 conducts heat. The nuts and seeds are heated and softened, and extruded by the screw rod 3 to discharge oil, the oil is discharged out of the outlet 25 under the oil manufacture processor 2a, the residue is extruded forward by the screw rod 3 and discharge out of the discharge hole 27 at the outer end. The oil manufacture structure and principle of the oil manufacture processor 2a are a widely-known technology, not to be detailed.

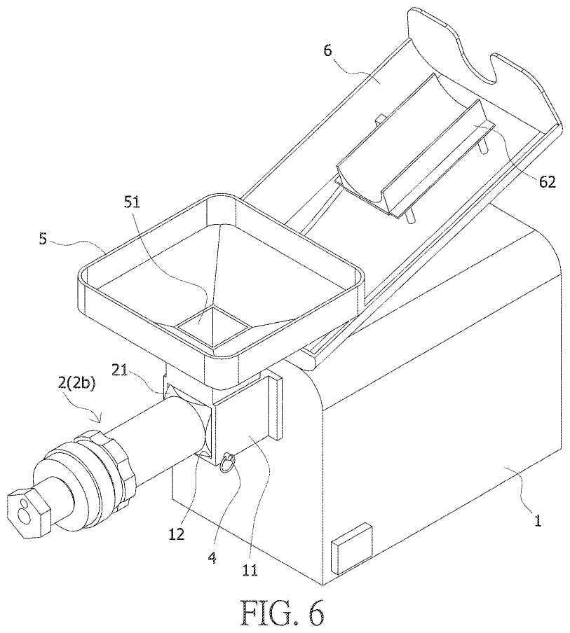

As shown in FIG. 1 and FIG. 6, the processor 2 is a grinding processor 2b, the grinding processor 2b is free from heating, when the feeding base 21 at the tail end is combined with the fixing base 11 of actuator 1, the nuts and seeds can be poured into the funnel 5 and processed. As a grinding disk (not disclosed) is arranged in the tube of grinding processor 2b, the nuts and seeds can be ground slowly, the paste is formed gradually and discharged out of the discharge hole 28 under the front end tube. The grinding structure and principle of the grinding processor 2h are a widely-known technology, not to be detailed.

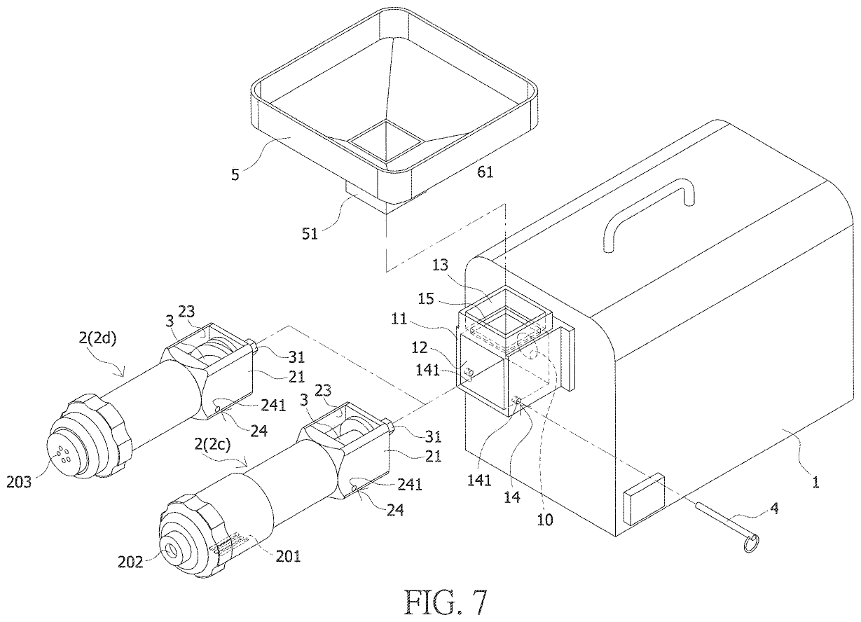

FIG. 7 shows the second embodiment of this case, differing from FIG. 1, the processor 2 is a juicing processor 2c which can squeeze vegetable and fruit juice or a noodle squeezing processor 2d. which can extrude noodles. When the feeding base 21 at the tail end of juicing processor 2c is combined with the fixing base 11 of actuator 1, the vegetable and fruit material can he processed. Finally, the juice is separated from the residue, the juice can be discharged out of the juice outlet 201 in the bottom of juicing processor 2c, the residue is discharged out of the discharge hole 202 in the outer end. The juicing structure and principle of the juicing processor 2c are a widely-known technology, not to be detailed.

As shown in FIG. 7, the processor 2 is a noodle squeezing processor 2d, when the feeding base 21 at the tail end is combined with the fixing base 11 of actuator 1, the feeding can begin, when the dough is put in the funnel 5, the noodle in circular or flat section is extruded through the extrusion hole 203 at the outer end of noodle squeezing processor 2d, and the noodles can he cooked and eaten. The noodle squeezing structure and principle of the noodle squeezing processor 2d are a widely-known technology, not to be detailed.

Moreover, as the juicing processor 2c and noodle squeezing processor 2d are free from heating during processing, the cover plate 6 at the upper edge of the power outlet of actuator I can he removed, the actuator I disclosed in FIG. 7 has been free of cover plate 6, this is different from the actuator 1 disclosed in FIG. 1.

We claim:

1. A multi-purpose food preparation machine with a replacea ale processor, comprising
an actuator (1) and a processor (2),
wherein the actuator (1) includes a motor (7) as a power output, an insertion hole (10) disposed at an output of the actuator (1);
the processor (2) is a hollow tubular body, one end of which is fixed to the motor (7) of the actuator (1), the processor (2) includes a screw rod (3) provided in the hollow tubular body of the processor (2), one end of the screw rod (3) has an insertion rod (31), which can be sleeved with a motor shaft (71) disposed in the actuator (1);
the actuator (1) includes a fixing base (11), which is a hollow and has an inner end connected with the insertion hole (10), a coupling mouth (12) disposed at an outer end of the fixing base (11), a first feeding inlet (13) disposed at an upper end of the fixing base (11), and first fixing part (14) disposed on both sides of the fixing base (11),
the processor (2) includes a feeding base (21) disposed at one end thereof, the feeding base (21) is a hollow and includes an axial hole (22) disposed at outer end of the feeding base (21), a second feeding inlet (23) disposed at an upper end of the feeding base (21), and second fixing part (24) disposed on both sides of the feeding base (21);
the feeding base (1) is inserted and installed in the fixing base (11) by the coupling mouth (12) of the fixing base (11); the second feed inlet (23) is directly below and corresponds to the first feed inlet (13); the second fixing part (24) and the first fixing part (14) are inserted through a fastener (4) to connect and fix the feeding base (21) and the fixing base (11);
an inner wall of the coupling mouth (12) of the fixing base (11) has at least one plane, an outer wall of the feeding base (21) has at least one plane that matches the plane of the inner wall of the coupling mouth (12).

2. The multi-purpose food preparation machine with the replaceable processor according to claim 1, wherein the first fixing part (14) of the fixing base (11) is left and right plug holes (141) for the fastener (4) inserted therethrough, the second fixing part (24) of the feeding base (21) is perforations (241) for the fastener (4) inserted therethrough, when the perforations (241) are aligned with the left and right plug holes (141), the pin can be inserted directly.

3. The multi-purpose food preparation machine with the replaceable processor according to claim 1, wherein the first fixing part (14) of the fixing base (11) includes the left and right plug holes (141) for inserting the fastener (4) and a first slot. (142) between two plug holes (141), the second fixing part (24) of the feeding base (21) is a second slot (242) for inserting the fastener (4), the fastener (4) is a pin, when the second slot (242) and the first slot (142) are vertically opposite to each other and coordinated with the left and right plug holes (141), the pin can be inserted directly.

4. The multi-purpose food preparation machine with the replaceable processor according to claim 1, wherein multi-purpose food preparation machine with replaceable processor defined in claim 1, the discharge part (51) under the funnel (5) can be inserted in the first feed inlet (13) of the fixing base (11), the inner wall of the first feed inlet (13) is provided with a flange (15) for stopping the discharge part (51).

5. The multi-purpose food preparation machine with replaceable processor defined in Claim 1, the upper edge of the power outlet of the actuator (1) is provided with a lift type cover plate (6), the cover plate (6) is provided with a feed inlet (61) vertically corresponding to the first feed inlet (13) of the fixing base (11).

6. The multi-purpose food preparation machine with the replaceable processor according to claim 5, wherein the bottom surface of the cover plate (6) is provided with a heater (62) far from the first feed inlet (13) for contacting the processor (2) and heating the processor (2).

7. The multi-purpose food preparation machine with the replaceable processor according to claim 6, wherein the processor (2) is an oil manufacture processor (2a) for squeezing vegetable oil, the outer wall of the oil manufacture processor (2a) is provided with a heat conducting outer tube (26) contacting the heater (62).

8. The multi-purpose food preparation machine with the replaceable processor according to claim 1, wherein the processor (2) is a grinding processor (2b) for grinding out paste food.

9. The multi-purpose food preparation machine with the replaceable processor according to claim 1, wherein the processor (2) is a juicing processor (2c) for squeezing vegetable and fruit juice.

10. The multi-purpose food preparation machine with the replaceable processor according to claim 1, wherein the processor (2) is a noodle squeezing processor (2d) for extruding noodles.
